(19) United States
(12) Patent Application Publication
(10) Pub. No.: US 2020/0308468 A1
(43) Pub. Date: Oct. 1, 2020

(54) CROSS-LINKED LEVAN BLENDS AS LOST CIRULATION MATERIALS

(71) Applicant: HPPE, LLC, Columbus, GA (US)

(72) Inventors: Ashoka V.R. MADDURI, Columbus, GA (US); Charles R. LANDIS, The Woodlands, TX (US); Matthew B. BLACKMAN, Columbus, GA (US); Sanket GANDHI, Columbus, GA (US)

(73) Assignee: HPPE, LLC, Columbus, GA (US)

(21) Appl. No.: 16/311,353

(22) PCT Filed: Jul. 7, 2017
(86) PCT No.: PCT/US2017/041094

§ 371 Date: Dec. 19, 2018

Related U.S. Application Data
(60) Provisional application No. 62/359,458, filed on Jul. 7, 2016.

(51) Int. Cl. C09K 8/20; C09K 8/08; C09K 8/035; C09K 8/512; C08B 37/00; E21B 21/00

(52) U.S. Cl. CPC C09K 8/206; C09K 8/08; C09K 8/035; E21B 49/008; C08B 37/0051; E21B 21/003; C09K 8/512

(57) ABSTRACT

The present invention is directed to compositions and methods for reducing lost circulation in drilling wells with compositions preferably comprising cross linked levan and calcium carbonate mixed with clay minerals such as kaolinite and other minerals blends or salts thereof.

### REFERENCE TO RELATED APPLICATIONS

This application claims priority to U.S. Provisional Application No. 62/359,458 of the same title and filed Jul. 7, 2016, the entirety of which is hereby incorporated by reference.

### FIELD OF THE INVENTION

The invention is directed to compounds and compositions of crosslinked Levan and blends of Levan with a range of mineral systems to enhance the performance of lost circulation materials (LCM) in oilfield, water well, directional drilling and wire-line coring operations, and to associated drilling methods.

### DESCRIPTION OF THE BACKGROUND

Advanced drilling fluids such as drilling muds are used throughout the drilling process for the exploration and development of oilfields around the world. These drilling fluids which may compose of a mix of biopolymer (e.g., xanthan gum, guar gum, welan, scleroglucan, glycol, starch, carboxymethyl/ethyl cellulose, schizophyllan or cellulose), synthetic polymer (polyacrylamides), and water or oil, circulates within the well bore, carries cuttings to the surface, and lubricates the drilling equipment. In drilling process these fluids are pumped downhole and are recirculated back to the surface for reconditioning. However, it is common that these fluids infiltrate highly porous rocks intersected during the drilling process. These fluids enter a porous or fractured formation and fail to return to the surface for recycling and reuse. Thus they are lost to the operations in the sub-terrane rather than returning through the annulus between the drill string and the formation walls. This problem is known as loss of fluid circulation through the drilling system. This loss of drilling fluid is a very significant problem in the industry due to the increased costs for making new fluid, operational time on the well site, and the addition equipment, and consumable product storage. Lost fluid circulation can lead to failures in testing drilled wells and decreased production performance. At present it is estimated that the lost fluid circulation costs $1 billion per year (see WO2013116072) to the industry in the United States alone.

The industry has attempted to address the problem with many different types of materials and techniques. The general concept is to introduce product after thorough geologic studies, such as fluid injection tests or other industry standardization, to understand the fracture and pore networks in the rocks to be drilled. Once the pore and fracture geometries of the network are known, then fluid engineers can design products to more efficiently bridge these openings in the rock.

Different types of loss circulation materials (LCM) have been used. LCMs with different particle compositions and size distribution are used to bridge the network and reduce levels of lost circulation. Common materials include fine, medium-sized and coarse calcium carbonate (approx. 0.1-3 mm in diameter respectively), synthetic graphite, coarse cellulosic fibers, fine cellulosic fibers, coarse nut shells, cellulose derivatives, mineral fibers etc. Ideally, a LCM additive would self-assemble in the well-bore from a small particle size in the fluid to a larger, bridging size as the fluid dewaters during the bridging process in the rock. If the LCM particle is too large in the fluid and is returned to the surface it too will be removed from the fluid by screening systems designed to maintain the fluid properties for onward recirculation. Although calcium carbonate can be easily ground for a specific fracture width and it is readily soluble in acid, it does not bind well with itself and the bridged network is not dynamic (i.e., change as needed) enough for variations in the geology or fluid composition. To compensate for these deficiencies, greater concentration of the material is required to effectively inhibit lost circulation. Other methods including resilient graphitic carbon of various sizes and plastic polymers-cellulose blends has been used in lost circulation compositions, but these materials can be expensive. Thus there is a need for improved compounds, compositions and methods to address LCM.

### SUMMARY OF THE INVENTION

The present invention overcomes the problems and disadvantages associated with current products, strategies and provide new chemical compositions and methods for the production and application of LCM's.

One embodiment of the invention is directed to compositions comprising crosslinked and/or non-crosslinked levan and calcium carbonate for use as LCM. Preferably the LCM is a liquid and calcium carbonate is added in powder form such as by grinding. Preferably the composition further contains phyllosilicate (e.g., clay minerals such as smectite, talc, muscovite, biotite, brucite, and the like), tectosilicate minerals, powder amorphous silica, alumina, metal oxides, and/or one or more polymers of a polysaccharide containing cross linker group. Preferably the polysaccharide comprises levan, dextran, guar gum, scleroglucan, welan, xanthan gum, starch, pullulan, schizophyllan, cellulose and/or combinations thereof, and preferably the cross linker contains from 1 to 10 carbons. Also preferably, the polymer contains substitutions along 1-100 percent of the polymer.

Another embodiment of the invention is directed to methods associated to drilling operations comprising the compositions of the invention used for producing in-situ bridging of the voids and fractures (e.g., porosity) by the LCM materials in the well bore.

Other embodiments and advantages of the invention are set forth in part in the description, which follows, and in part, may be obvious from this description, or may be learned from the practice of the invention.

### DESCRIPTION OF THE FIGURES

FIG. 1 Preparation of crosslinked levan.

FIG. 2 Carbonate-based product mixed with clay minerals such as kaolinite as a Lost Circulation Material.

FIG. 3 Summary of filtrate control.

FIG. 4 Permeability plugging test results.

FIG. 5 Spurt loss results.

### DESCRIPTION OF THE INVENTION

Loss circulation materials (LCM) generally comprise particles in a fluid that are designed to plug voids, pores, vugs and/or fractures in a drilling operation. Generally available LCM are large and return to the surface of a drilling operation and removed by screening systems designed to maintain the fluid properties for recirculation. LCM such as calcium carbonate are conventionally available, and easily ground for a specifically desired fracture width, calcium carbonate does not bind well with itself or with the solid structure of the well. In addition, calcium carbonate is not dynamic and adaptable to different drilling environments, and does not form bridged networks (e.g., cross links and bonding to walls) as needed for variations in the geology or fluid composition. To compensate for these deficiencies, greater concentrations of calcium carbonate are used to effectively inhibit lost circulation, but the greater composition increase both expenses and difficulty. In addition,

It has been surprisingly discovered that compounds and compositions of the invention improve the binding strength of the components of LCM materials to other components and to solid structures such as the rock and structures within drilling operations. As a consequence, voids, pores, vugs and fractures produced in drilling operations are plugged, which reduces the loss of circulation fluid. Compositions of the invention comprise an engineered, solid-phase material made from two or more constituent materials with significantly different physical or chemical properties. The constituent materials can be linked chemically and remain distinct on a macroscopic level within the finished, solid-phase structure. Calcium such as calcium carbonate and clay minerals also increase the density of the drilling fluid adding to fluid rigidity and stability. The composition preferably contains a crosslinked and/or non-crosslinked polymer and a form of carbonate or a clay mineral. Preferably, the polymer comprises one or more of levan, dextran, guar gum, scleroglucan, welan, xanthan gum, schizophyllan, levan and/or cellulose. Preferably the calcium is calcium carbonate and/or calcium containing chemical variations thereof, and preferably the clay mineral comprises, for example, clay, kaolinite, halloysite, salts of the foregoing and the like.

One embodiment of the invention is directed to a composition comprising a cross linked and/or non-cross linked polymer and a form of carbonate or a clay mineral. Preferably, the polymer comprises one or more of a polysaccharide, levan, dextran, guar gum, scleroglucan, welan, xanthan gum, schizophyllan, levan and/or cellulose. Preferably the calcium is calcium carbonate and/or calcium containing chemical variations thereof, and preferably the clay mineral comprises, for example, clay, kaolinite, halloysite, dickite, montmorillonite, salts of the foregoing, and similar compounds. Calcium carbonate is a chemical compound of the formula CaCO₃, which is the majority component of limestone and the shells of various marine organisms. Calcium carbonate is formed by reacting calcium with carbonate. Cross links between polymers preferable contain a carbon linker and/or long chain hydroxy aliphatic groups or salts as side chains which may also contain a carbon linker. Carbon linkers form links between polymers that may contain from 1 to 10 carbon atoms, preferably from 1 to 8 carbon atoms, preferably from 1 to 6 carbon atoms, preferably from 1 to 4 carbon atoms, and preferably from 1 to 2 carbon atoms. Cross linking may be from polymer backbone to polymer backbone, or from side chain moieties to other side chain moieties, or to polymer backbones.

LCM compositions of the invention may include additional components such as, for example, cellulosic fibers, crump rubber particles, graphite, thermosets, and thermoplastics. Compositions may also include oil and other blending agents to modify performance characteristics (e.g., rigidity, swelling, and lubrication) or material handling properties. Additional ingredients that can be included with compositions of the invention include sodium carbonate, bentonite, caustic soda, gypsum, barite, defoamers, flocculants and combinations thereof.

Another embodiment of the invention is directed to method to reduce loss of drilling fluid in a drilling operation. The methods comprise providing a drilling fluid, adding a LCM of the invention, as described herein, to the drilling fluid to form a mixture, and performing the drilling operation with the mixture. The LCM of the invention may be added as a solid (e.g., powder) or a liquid. Compositions typically exists as a slurry when combined with drilling fluid, but becomes a high moisture solid in a drilling operation, such as when circulated within a well. The compositions for use as lost circulation materials are economical while efficiently sealing cracks and pressure at higher temperatures as compared with conventional and commercially available lost circulation materials.

Another embodiment of the invention comprises methods for the manufacture of LCM compositions of the invention. Methods comprise cross linking a polymer with a cross linking agent. Cross linking agents and their uses are well known to those skilled in the art. For example, epichlorohydrin (EPCH) cross links polymers containing polyamines. Other cross linking agents include, but are no limited to mono-, di- and tetra-ethylene glycol diacrylate, mono-, di- and tri-thylene glycol dimethacrylate, and derivatives of methylenebisacrylamide.

Reactions are preferably performed in an aqueous environment and under conditions known to those skilled in the art. From 1 to 100 percent of the polymer may be cross linked, preferably from 5-90 percent of the polymer, preferably from 10 to 75 percent, preferably from 20 to 50 percent, and preferably from 25-35 percent. Cross linking may be from polymer backbone to polymer backbone, or from side chain moieties to other side chain moieties, or to polymer backbones. The amount of cross linking desired is related to the drilling operation, the material being drilled and the desired polymer.

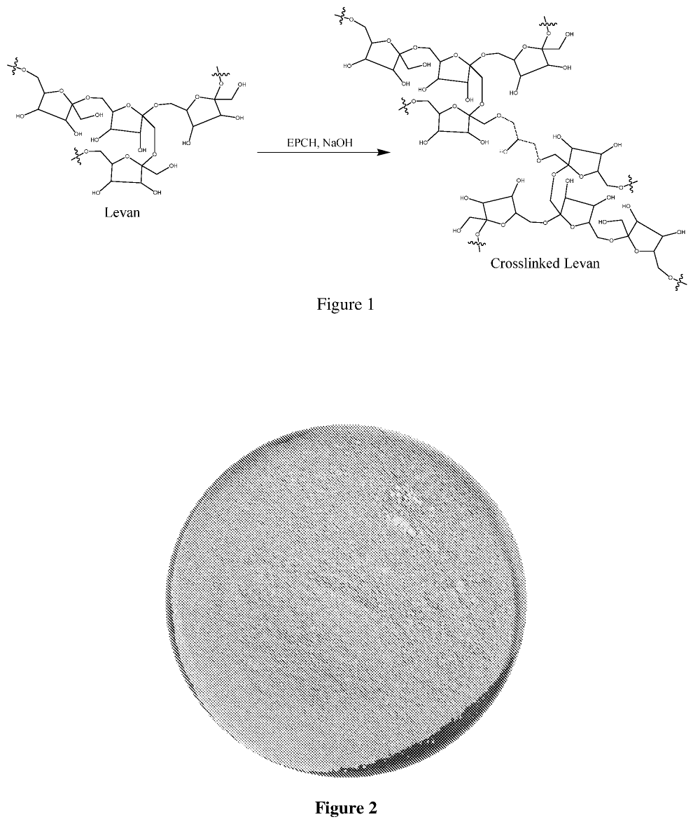

Another embodiment of the invention is directed to the preparation of crosslinked levan and polysaccharide derivatives. A schematic of the process is shown in FIG. 1, which when optionally modified with EPCH crosslinked, serves as a single component binder. The polymer can vary rather broadly in type and, preferably, is sufficiently stable so as to be effective under the process conditions used commercially (e.g., high temperatures and strong caustic conditions).

Generally, crosslinked polymers produced by reacting the containing the pendant reactive group, in solution, with a epichlorohydrin or its salt at a temperature ranging from about 50° C. to 90° C. for several hours. From about 1-90 percent of the available pendant reactive groups of the polymer may be replaced by epichlorohydrin in accordance with said procedures. The molecular weight of the polymers useful in the process of the present invention range from about 1 million to 50 million Dalton, preferable from about 2 million to 40 million Dalton, preferable from about 5 million to 30 million Dalton, and preferable from about 10 million to 20 million Dalton.

The polymers used in the present invention are employed by adding them, usually in the form of a dilute aqueous solution, to the calcium carbonate and/or clay minerals. Preferably, the crosslinked polymer is levan and comprises at least about 1 gpb, but higher amounts may be employed, depending in part on the variations of the drilling operation. Generally, a point is reached in which additional amounts of crosslinked levan do not improve the separation rate over already achieved maximum rates. Thus, it is uneconomical to use excessive amounts when this point is reached.

The following examples illustrate embodiments of the invention, but should not be viewed as limiting the scope of the invention.

### EXAMPLE 1

### Preparation of Crosslinked Levan

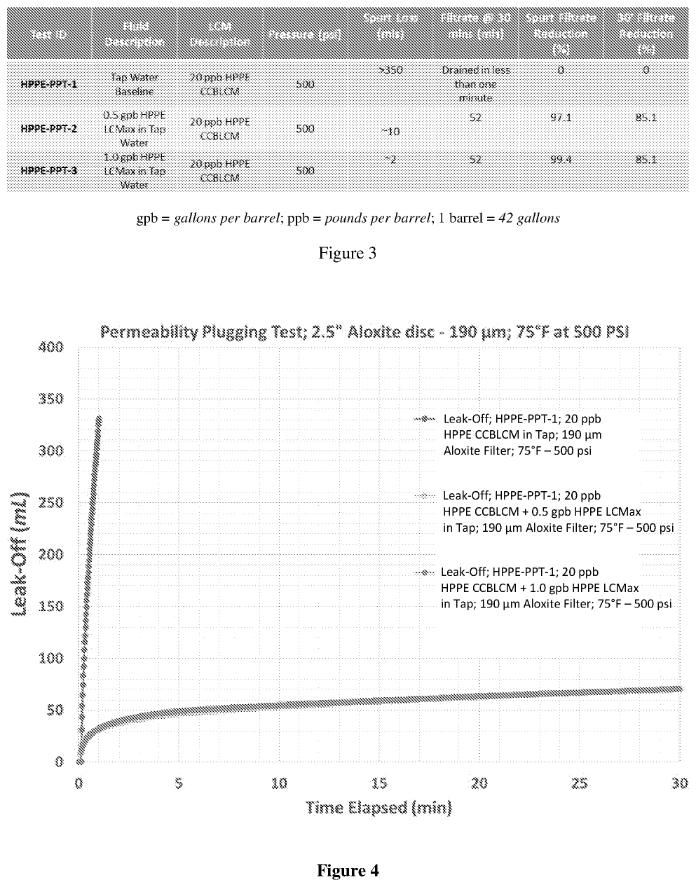

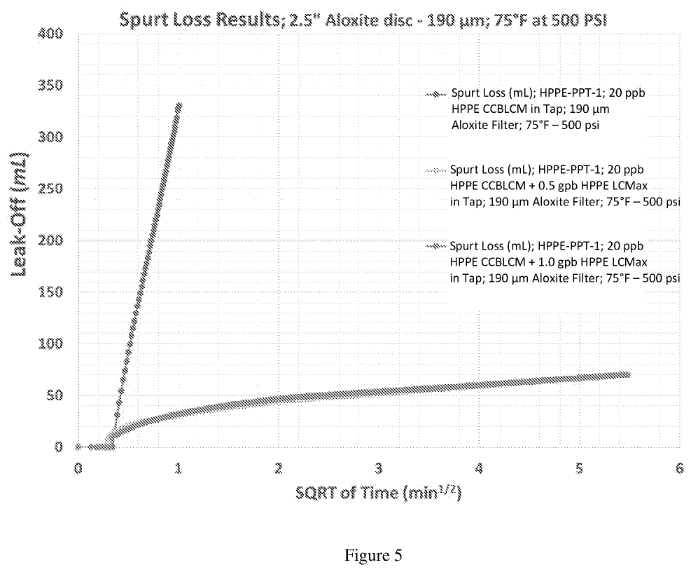

Levan polysaccharide was reacted with cross linker epichlorohydrin (EPCH) in water and base (NaOH) at elevated reaction temperatures as depicted in FIG. 1. Crosslinked Levan was produced as LCMax, TacBond, Spectre 82x, Spectre 825x and Spectre 8255x. Permeability plugging test results indicate that 0.5 gpb of crosslinked levan (LCMax) effectively improves the bridging performance of a CCBLCM (calcium carbonate-based product mixed with clay minerals such as kaolinite) (see FIG. 1) in tap water (see FIGS. 3 and 4). Total mixed fluid filtered through the aloxite disc (see FIG. 2) within the first minute of the baseline 20 ppb BS 663 in tap water test. CCBLCM gave minimum fluid loss control in the baseline test and thirty-minute filtrate volumes were similar for both the 0.5 gpb and 1.0 gpb loadings of LCMax. Spurt was significantly lower for the 1.0 gpb treatment and lower concentrations of LCMax could be effective as well (see FIG. 5). Alternatively, less CCBLCM could be used when 0.5 gpb LCmax is used.

Other embodiments and uses of the invention will be apparent to those skilled in the art from consideration of the specification and practice of the invention disclosed herein. All references cited herein, including all publications, and all U.S. and foreign patents and patent applications are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A composition comprising a crosslinked and/or non-crosslinked polymer and calcium carbonate or a clay mineral.

2. The composition of claim 1, wherein the polymer comprises a polysaccharide, levan, dextran, guar gum, scleroglucan, welan, xanthan gum, starch, pullulan, schizophyllan, cellulose and/or combinations thereof.

3. The composition of claim 1, wherein the polymer contains a cross link containing from 1 to 10 carbons.

4. The composition of claim 1, wherein the polymer contains chemical substitutions along 1-100 percent of the polymer backbone.

5. The composition of claim 1, which is a powder or an aqueous mixture.

6. The composition of claim 1, further comprising cellulosic fibers, crump rubber particles, graphite, thermosets, thermoplastics, blending agents, sodium carbonate, bentonite, caustic soda, gypsum, barite, defoamers, flocculants and combinations thereof.

7. The composition of claim 1, further comprising a drilling fluid.

8. A method of reducing loss of a circulating drilling fluid in association with a drilling operation comprising:
adding a crosslinked and/or non-crosslinked polymer and calcium carbonate to the circulating drilling fluid to form a mixture; and
performing the drilling operation with the mixture as the drilling fluid.

9. The method of claim 8, wherein the polymer comprises a polysaccharide, levan, dextran, guar gum, scleroglucan, welan, xanthan gum, starch, pullulan, schizophyllan, cellulose and/or combinations thereof.

10. The method of claim 8, wherein the polymer contains a cross link containing from 1 to 10 carbons.

11. The method of claim 8, wherein the polymer contains chemical substitutions along 1-100 percent of the polymer backbone.

12. The method of claim 8, wherein the mixture reduces loss of drilling fluid to voids, pores, vugs and/or fractures during the drilling operation.

13. The method of claim 8, further comprising determining porosity of a drilling substrate.

14. The method of claim 13, wherein porosity of the drilling substrate is determined by a fluid injection test.

15. A method for manufacture of a LCM composition comprising:
providing a polysaccharide;
treating the polysaccharide with a cross linker to form cross linked polysaccharide; and
adding calcium carbonate to the cross-linked polysaccharide to form the LCM composition.

16. The method of claim 16, wherein the polysaccharide is levan, dextran, guar gum, scleroglucan, welan, xanthan gum, starch, pullulan, schizophyllan, cellulose and/or combinations thereof.

17. The method of claim 15, wherein the cross linker is epichlorohydrin.

18. The method of claim 15, further comprising adding one or more of oil, a blending agent, sodium carbonate, bentonite, caustic soda, gypsum, barite, a defoamer, a flocculant, and/or combinations thereof to the LCM composition.

19. The method of claim 18, wherein the blending agent modifies a performance characteristic of the LCM composition.

20. The method of claim 18, wherein the performance characteristic is one or more of rigidity, swelling, lubrication, and/or handling properties.
